(19) United States
(12) Patent Application Publication
(10) Pub. No.: US 2005/0010837 A1
(43) Pub. Date: Jan. 13, 2005

(54) Method and apparatus for managing adapters in a data processing system

(75) Inventors: James R. Gallagher, Austin, TX (US); Binh K. Hua, Austin, TX (US); Sivarama K. Kodukula, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/616,848

(22) Filed: Jul. 10, 2003

(51) Int. Cl. G06F 11/00

(52) U.S. Cl. 714/100

(57) ABSTRACT

A method, apparatus and computer instructions for handling a failure of a primary adapter in a data processing system. The primary adapter is monitored for the failure by the device driver. A standby adapter handled by the device driver is switched in place of the primary adapter in response to detecting the failure.

### BACKGROUND OF THE INVENTION

1. Technical Field

The present invention relates generally to an improved data processing system and in particular, a method and apparatus for processing data. Still more particularly, the present invention provides a method, apparatus, and computer instructions for managing adapters in a data processing system.

2. Description of Related Art

A network data processing system is a system that transmits data between different data processing systems. The network data processing system includes the network operating system in the client and server machines, the cables connecting them and all supporting hardware in between such as bridges, routers and switches. In wireless systems, antennas and towers are also part of the network data processing system.

A server is a data processing system that is shared by a number of other client data processing systems. A server provides data, such as boot files, operating system images, and applications to clients. For example, a Web server provides Web pages to hundreds or even thousands of different clients on a regular basis. One desired feature of a server is to provide uninterrupted networking services for its clients, even in the event of a hardware failure.

For example, if a network adapter fails on a server, another network adapter may be brought into use through a failover mechanism or procedure. A failover mechanisms switches from a primary or current unit to a standby or back-up unit in the event a primary or current unit fails. The time in which a switch between units occurs is critical for some real-time applications. Currently, failover mechanisms for network adapters are handled on the Transmission Control Protocol (TCP)/Internet Protocol (IP) layer with an application in the user space managing the failover process. This current process is lengthy with respect to real-time applications and may result in a loss of data or other interruption in a failover process.

Therefore, it would be advantageous to have an improved method, apparatus, and computer instructions for a failover process for adapters.

### SUMMARY OF THE INVENTION

The present invention provides a method, apparatus and computer instructions for handling a failure of a primary adapter in a data processing system. The primary adapter is monitored for the failure by the device driver. A standby adapter handled by the device driver is switched in place of the primary adapter in response to detecting the failure.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system that may be implemented as a server in accordance with a preferred embodiment of the present invention;

FIG. 2 is a diagram illustrating a conventional known failover architecture in accordance with a preferred embodiment of the present invention;

FIG. 3 is a diagram illustrating a failover architecture in accordance with a preferred embodiment of the present invention; and

FIG. 4 is a flowchart of a process for managing network adapters is in accordance with a preferred embodiment of the present invention.

### DETAILED DESCRIPTION OF THE PREFERRED EMBODIMENT

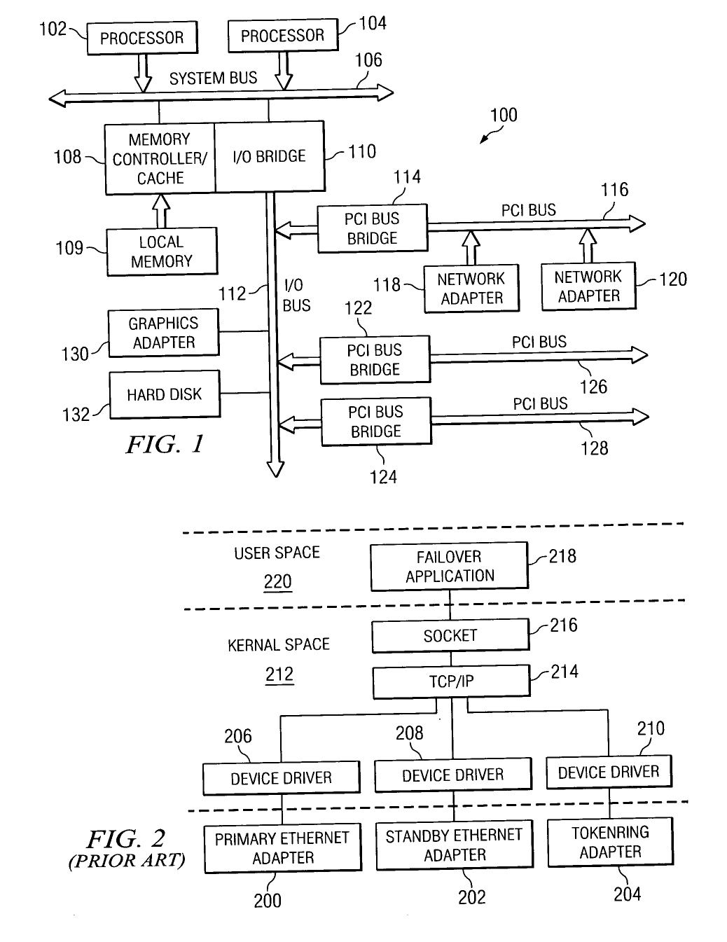

Referring to FIG. 1, a block diagram of a data processing system that may be implemented as a server is depicted in accordance with a preferred embodiment of the present invention. Data processing system 100 may be a symmetric multiprocessor (SMP) system including a plurality of processors 102 and 104 connected to system bus 106. Alternatively, a single processor system may be employed. Also connected to system bus 106 is memory controller/cache 108, which provides an interface to local memory 109. I/O bus bridge 110 is connected to system bus 106 and provides an interface to I/O bus 112. Memory controller/cache 108 and I/O bus bridge 110 may be integrated as depicted.

Peripheral component interconnect (PCI) bus bridge 114 connected to I/O bus 112 provides an interface to PCI local bus 116. A number of modems may be connected to PCI local bus 116. Typical PCI bus implementations will support four PCI expansion slots or add-in connectors. Communications links to clients may be provided through network adapter 118 and network adapter 120 connected to PCI local bus 116 through add-in boards.

Additional PCI bus bridges 122 and 124 provide interfaces for additional PCI local buses 126 and 128, from which additional network adapters or modems may be supported. In this manner, data processing system 100 allows connections to multiple network computers. A memory-mapped graphics adapter 130 and hard disk 132 may also be connected to I/O bus 112 as depicted, either directly or indirectly.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

Turning now to FIG. 2, a diagram illustrating a conventional known failover architecture is depicted in accordance with a preferred embodiment of the present invention. In this example, a data processing system includes primary Ethernet adapter 200, standby Ethernet adapter 202, and Tokenring adapter 204. Device drivers 206, 208 and 210 are present in kernel space 212. A device driver is a program or routine that links a peripheral device to the operating system. A device driver receives calls from applications or other process to perform functions with respect to a peripheral device, such as a network adapter or a printer. The device driver contains the precise machine language or other code necessary to perform the functions requested by an application. Device drivers 206, 208 and 210 are associated with these adapters on a one-to-one basis. In other words, one device driver is associated with one network adapter such that each network adapter has its own copy of a device driver. The data between these network adapters are not shared. For example, the data between primary Ethernet adapter 200 and standby Ethernet adapter 202 are not shared.

TCP/IP layer 214 and socket layer 216 also are present. TCP/IP layer 214 maintains the IP address of the adapter and IP address switching between adapters in the event of a failover TCP/IP layer 214 contains the failover mechanism for switching between adapters in the event of a failover. Socket layer 216 is the glue logic/layer between the Application/User and TCP/IP layer 214. The socket normally makes a connection and sends data to the other station. When failover happens, all the connections on the socket are lost when the IP address switches between the primary and standby adapters. The socket connection then needs to be re-established after the IP addresses are switched.

Failover application 218 in user space 220 performs the monitoring to detect whether the network adapters are active. This monitoring may be performed using different known processes, such as a heartbeat mechanism in which a device sends or broadcasts a signal to indicate the status of the device.

During initial program load (IPL), primary Ethernet adapter 200 is configured with an alternative media access controlled (MAC) address. Standby Ethernet adapter 202 is configured with a built-in MAC address.

Both network adapters have their own unique IP addresses.

Failover application 218 keeps track of the health or status of primary Ethernet adapter 200 using a heartbeat mechanism. If the heartbeat signal is not detected for some period of time, failover application 218 initiates the failover process.

The first step in the failover process is to bring the TCP/IP interface of primary Ethernet adapter 200 down and unload device driver 206 from kernel space 212. Next, the TCP/IP interface of standby Ethernet adapter 202 is brought down and device driver 208 is unloaded from kernel space 212. The MAC address of primary Ethernet adapter 200 is loaded to standby Ethernet adapter 202, and standby Ethernet adapter 202 is configured with the IP address of primary Ethernet adapter 200. Now, standby Ethernet adapter 202 becomes the new current primary Ethernet adapter. Next, primary Ethernet adapter 200 is loaded with built-in MAC address and configured with the IP address of standby Ethernet adapter 202. Primary Ethernet adapter 200 becomes the new current standby Ethernet adapter.

As can be seen, the different failover processes take place in user space 220 and kernel space 212. These processes take time during which data may be lost in the switching between primary Ethernet adapter 200 and standby Ethernet adapter 202.

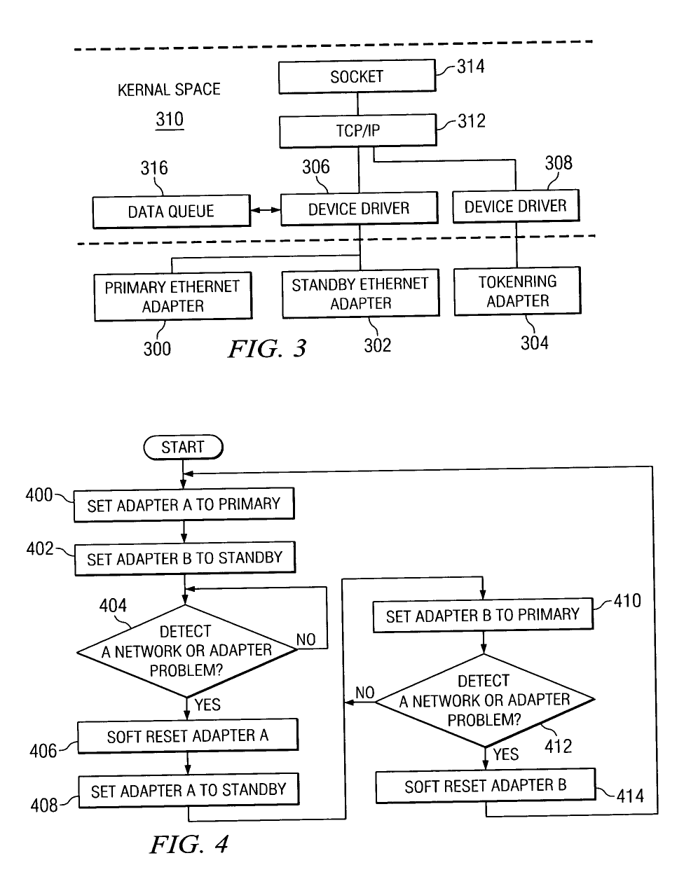

Turning next to FIG. 3, a diagram illustrating a failover architecture is depicted in accordance with a preferred embodiment of the present invention. In this example, primary Ethernet adapter 300, standby Ethernet adapter 302 and Tokenring 304 are present in a data processing system. Device drivers 306 and 308 are present in kernel space 310. Kernel space 310 also includes TCP/IP layer 312 and socket layer 314.

According to a preferred embodiment of the present invention, a single driver, device driver 306 is employed to handle two or more adapters, such as primary Ethernet adapter 300 and standby Ethernet adapter 302. Device driver 306 monitors primary Ethernet adapter 300 to determine whether this adapter is properly working or if a failure has occurred. Additionally, device driver 306 handles the failover process without intervention from the upper layer protocols.

In this manner, the time needed to detect a network error is decreased. Device driver 306 may almost instantly detect a link loss by primary Ethernet adapter 300. With a faster failover process, data integrity may be preserved during the transition from the failed adapter to the new adapter. Further, data may be shared between the adapters since device driver 306 handles both adapters. In this example, device driver 306 transmits data using data queue 316. During a failover process, device driver 306 does not need to be unloaded as with the prior process. Data in data queue 316 may be maintained and used by the new adapter switched in place of the failed adapter.

During IPL, device driver 306 configures both primary Ethernet adapter 300 and standby Ethernet adapter 302. Primary Ethernet adapter 300 is configured as “normal”, as in the previous method. Standby Ethernet adapter 302 is configured to mirror the PCI configuration register content of primary Ethernet adapter 300 with the exception that the “Bus Master” and “IO space” bits are disabled. By setting the Bus Master bit, primary Ethernet adapter 300 is allowed to act as a Bus Master on the PCI bus in these examples.

The PCI configuration registers are located on the adapter. The IO space is a bit in the command register and command register is one of register in the PCI configuration registers. This bit is used to control the IO access to the IO space in the adapter. The adapter only responds to the IO access when this bit is set to one/enable.

The MAC address settings for primary Ethernet adapter 300 and standby Ethernet adapter 302 are the same as before. Primary Ethernet adapter 300 has an alternative MAC address and standby Ethernet adapter 302 uses the built-in MAC address. Device driver 308 uses the same IP address for both primary Ethernet adapter 300 and standby Ethernet adapter 302. A new polling routine is added to device driver 306 to generate or handle the heartbeat process used to monitor for a failure in primary Ethernet adapter 300.

The failover steps are much quicker with this configuration in contrast to the currently available architecture illustrated in FIG. 2. This configuration allows applications and processes above device driver 306 to continue working without interruption. When device driver 306 detects a network problem on primary Ethernet adapter 300, device driver 306 issues a soft reset to primary Ethernet adapter 300. After the reset, the Bus Master and IO space of primary Ethernet adapter 300 are disabled in the PCI configuration and command register. Primary Ethernet adapter 300 uses the built-in MAC address as a default in this example. Failing primary Ethernet adapter 300 becomes the new standby adapter. Standby Ethernet adapter 302 is reprogrammed to contain the alternative MAC address of primary Ethernet adapter 300.

Next, the Bus Master and IO space are enabled in the PCI configurations command register for standby Ethernet adapter 302. Standby Ethernet adapter 302 is now the new primary adapter, and device driver 306 can start sending the data from data queue 316 to the new primary Ethernet adapter for transfer. During the failover process, the higher protocol, such as TCP/IP layer 312, can keep sending data through the same IP interface. The status of the device is still active/open and TCP/IP layer 312 is unaware of the occurrence of the failover process. Device driver 306 queues the data in data queue 316 for service by the new primary Ethernet adapter. Due to the fast switchover, the window for losing the receive data is much smaller than in the current failover approach. If any receive data is lost during the transition, the data may be recovered using normal TCP/IP recovery methods, such as an “Acknowledge” timeout.

Turing now to FIG. 4, a flowchart of a process for managing network adapters is depicted in accordance with a preferred embodiment of the present invention. The process illustrated in FIG. 4 may be implemented in a device driver, such as device driver 306 in FIG. 3.

The process begins by setting adapter A as a primary adapter (step 400). Adapter A is set as a primary adapter by enabling Bus Master capability and IO space. The MAC address is set to the alternative MAC address assigned by the device driver. Next, adapter B is set as a standby adapter (step 402). In step 402, the Bus Master and IO space are disabled. Additionally, the MAC address is set to the built-in MAC address for the adapter.

A determination is then made as to whether a network or adapter problem is detected (step 404). This step is performed by using a heartbeat process. If a heartbeat is received within a select period of time, then the adapter is assumed to be functioning properly. If a heartbeat is not received, then a problem is assumed to exist. If a problem is not detected, the process returns to step 404.

Otherwise, a soft reset of adapter A is initiated (step 406). A soft reset is used to reset the adapter hardware logic and place the adapter back to the IPL's default state. The soft reset may often clear up a situation causing the adapter problem detected in step 404. As such, this adapter can now play the role of a standby adapter. Adapter A is then set to a standby state (step 408). Adapter A is switched from a primary state to a standby state by disabling the Bus Master and IO space. Additionally, the MAC address is switched to the built-in MAC address for adapter A. Adapter B is now set as the primary adapter (step 410). Adapter B is switched from being a standby adapter to the primary adapter by enabling Bus Master and IO space. Further, the MAC is set to the alternative MAC address used by the device driver for accessing the primary adapter.

The process then determines whether a network or adapter problem is detected (step 412). If a problem is not detected, the process returns to step 412. Otherwise, a soft reset of adapter B is initiated with the process then returning to step 400 as described above.

Thus, the present invention provides a method, apparatus, and computer instructions for managing adapters in a failover process. The mechanism of the present invention is implemented in a device driver to enable faster processing of adapters during a failover process. Further, the device driver handles the primary adapter as well as any standby adapter, rather than having a separate device driver for each adapter. This process eliminated having to unload a device driver for the failed adapter and then reconfiguring the standby adapter. Further, with the device driver handling the primary and standby adapters, data may be shared between the adapters when a failover process is initiated. In this manner, the amount of time needed for a failover process is reduced along with a reduction in the possibility of data loss occurring.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted examples illustrate a failover process with respect to a network adapter, the mechanism of the present invention may be applied to other types of adapters or devices handled by a device driver. For example, this mechanism may be applied to graphics adapters or printers.

The embodiment was chosen and described in order to best explain the principles of the invention, the practical application, and to enable others of ordinary skill in the art to understand the invention for various embodiments with various modifications as are suited to the particular use contemplated.

1. A method in a device driver for handling a failure of a primary adapter in a data processing system, the method comprising:
monitoring the primary adapter for the failure; and
responsive to detecting the failure, switching to a standby adapter handled by the device driver.

2. The method of claim 1, wherein the failure is an occurrence of at least one of a network problem and a port problem.

3. The method of claim 1, wherein the primary adapter is on a first port and the standby adapter is on a second port and wherein the switching step comprises:
switching from the first port to the second port to switch to the standby adapter.

4. The method of claim 3, wherein the first port is assigned an active media access control address prior to a switch from the primary adapter to the standby adapter and wherein the switch from the first port to the second port is made by assigning the second port to an active media access control address.

5. The method of claim 3 further comprising:
initiating a soft reset of the first port.

6. The method of claim 1, wherein the primary adapter is a network adapter.

7. The method of claim 1, wherein the primary adapter is a graphics adapter.

8. A data processing system for handling a failure of a primary adapter in a data processing system, the data processing system comprising:
monitoring means for monitoring the primary adapter for the failure; and
switching means for switching to a standby adapter handled by the device driver responsive to detecting the failure.

9. The data processing system of claim 8, wherein the failure is an occurrence of at least one of a network problem and a port problem.

10. The data processing system of claim 8, wherein the primary adapter is on a first port and the standby adapter is on a second port and wherein the switching means comprises:
means for switching from the first port to the second port to switch to the standby adapter.

11. The data processing system of claim 10, wherein the first port is assigned an active media access control address prior to a switch from the primary adapter to the standby adapter and wherein the switch from the first port to the second port is made by assigning the second port to an active media access control address.

12. The data processing system of claim 10 further comprising:
initiating means for initiating a soft reset of the first port.

13. The data processing system of claim 8, wherein the primary adapter is a network adapter.

14. The data processing system of claim 8, wherein the primary adapter is a graphics adapter.

15. A computer program product in a computer readable medium for handling a failure of a primary adapter in a data processing system, the computer program product comprising:
first instructions for monitoring the primary adapter for the failure; and
second instructions for switching to a standby adapter handled by the device driver responsive to detecting the failure.

16. The computer program product of claim 15, wherein the failure is an occurrence of at least one of a network problem and a port problem.

17. The computer program product of claim 15, wherein the primary adapter is on a first port and the standby adapter is on a second port and wherein the second instructions comprise:
sub-instructions for switching from the first port to the second port to switch to the standby adapter.

18. The computer program product of claim 17, wherein the first port is assigned an active media access control address prior to a switch from the primary adapter to the standby adapter and wherein the switch from the first port to the second port is made by assigning the second port to an active media access control address.

19. The computer program product of claim 17 further comprising:
fourth instructions for initiating a soft reset of the first port.

20. The computer program product of claim 15, wherein the primary adapter is a network adapter.

21. The computer program product of claim 15, wherein the primary adapter is a graphics adapter.

22. A server data processing for obtaining cultural context information from a client, the server data processing system comprising:
a bus system;
a communications unit connected to the bus system;
a memory connected to the bus system, wherein the memory includes a set of instructions; and
a processing unit connected to the bus system, wherein the processing unit executes instructions for a device driver to monitor the primary adapter for the failure and, switch to a standby adapter handled by the device driver in response to detecting the failure.
